(19) United States
(12) Patent Application Publication
(10) Pub. No.: US 2016/0371515 A1
(43) Pub. Date: Dec. 22, 2016

(54) APPARATUS AND METHOD FOR TRANSMITTING AND RECEIVING RF SIGNAL USING BEAMFORMING

(71) Applicant: Electronics and Telecommunications Research Institute, Daejeon (KR)

(72) Inventors: Jae-Young JUNG, Daejeon (KR); Chan-Won PARK, Daejeon (KR); Won-Kyu CHOI, Daejeon (KR)

(21) Appl. No.: 14/966,528

(22) Filed: Dec. 11, 2015

(30) Foreign Application Priority Data
Jun. 18, 2015 (KR) 10-2015-0086384

(51) Int. Cl. G06K 7/10

(52) U.S. Cl. CPC G06K 7/10009; G06K 7/10158

(57) ABSTRACT

Disclosed herein are an apparatus and method for transmitting and receiving an RFID signal using beamforming. The apparatus for transmitting and receiving a Radio Frequency Identification (RFID) signal using beamforming according to an embodiment includes a reception unit for receiving power and RFID data signals from an RFID reader, a control unit for adjusting opening/closing periods of switches corresponding to respective paths through which the RF data signals pass, thus controlling the paths, and a transmission unit for converting phases of RF data signals, which are distributed and transmitted to the paths, in response to the opening/closing periods of the switches, and then transmitting beams corresponding to the RF data signals while converting a pattern of the beams.

### CROSS REFERENCE TO RELATED APPLICATION

This application claims the benefit of Korean Patent Application No. 10-2015-0086384, filed Jun. 18, 2015, which is hereby incorporated by reference in its entirety into this application.

### BACKGROUND OF THE INVENTION

1. Technical Field

The present invention generally relates to an apparatus for transmitting and receiving a Radio Frequency Identification (RFID) signal using beamforming, and more particularly to technology that implements beamforming using a phase converter, which is capable of minimizing the loss of a high-power signal from an RFID reader transmitting/receiving an RFID signal, and then transmits and receives an RFID signal.

2. Description of the Related Art

Generally, RFID technology is technology for attaching tags to respective objects, recognizing the unique identifier (ID) of the objects in a wireless manner, and collecting, storing, processing, and tracking corresponding information, thus providing services such as positioning, remote processing, and management of objects and information exchange between objects. This technology obviates the need either to directly touch a tag, as in the case of an existing barcode, or to scan a tag within a visible band. Owing to this advantage, RFID technology is evaluated as a technology that is capable of replacing barcodes, and the range of utilization thereof has extended.

A 900 MHz Ultra-High Frequency (UHF) RFID system is a passive type, and uses back-scattering modulation as a data transmission scheme. Here, the term “back-scattering modulation” denotes a method of, when a tag scatters a Continuous Wave (CW), transmitted from a reader, and returns the scattered CW to the reader, sending the information of the tag by changing the intensity of the scattered electromagnetic wave.

A conventional 900 MHz UHF RFID system is described with reference to FIG. 1. FIG. 1 is a configuration diagram of a conventional typical 900 MHz UHF RFID system.

Referring to FIG. 1, the 900 MHz UHF RFID system includes an RFID reader and an RFID tag. The RFID reader includes a reader transmitter, a reader receiver, and a modulation/demodulation frequency generator.

The reader transmitter includes a digital-to-analog converter (DAC) for converting a digital reader command signal into an analog signal, a low-pass filter, a modulator for up-converting the analog signal into an RF signal, a drive amplifier for increasing the gain in order to supply sufficient energy to the tag, a power amplifier, a band-pass filter, and a transmitting antenna. The reader receiver includes a receiving antenna, a band-pass filter for suppressing the noise of a response signal received from the tag, a low-noise amplifier, a demodulator for converting the received response signal into a baseband signal, a baseband filter, a baseband amplifier, and an analog-to-digital converter (ADC) for converting an analog signal into a digital signal. The modulation/demodulation frequency generator generates frequencies respectively input to the modulator and the demodulator.

In accordance with the communication protocol of a passive RFID system, when the reader transmitter receives a baseband signal from a digital unit, for example, a modem, it alternately transmits a modulated signal and a CW signal. When the reader transmitter transmits the modulated signal, the tag merely receives the signal but does not send a response signal to the signal, and thus the reader receiver receives no signal. In contrast, when the reader transmitter transmits the continuous wave, a response signal is received from the tag, and thus the reader receiver receives and processes the response signal.

The tag absorbs part of the CW signal received from the reader and reflects the remaining part of the CW signal. The signal reflected in this way is the response signal from the tag, and carries tag information by changing the reflectivity of the signal. The reader performs reception while transmitting the CW signal. As a result, at the reader, the same frequency is used for both transmission and reception.

The scheme for data transmission between the tag and the reader is described below. That is, for an electromagnetic signal transmitted from the reader through a wireless communication channel, a backscattered signal having the same frequency as the electromagnetic signal is returned via the impedance mismatch of the tag. Here, the returned backscattered signal undergoes serious distortion of the magnitude and phase thereof due to the influence of the multipath fading of the surrounding environment. Due thereto, a problem arises in that it is difficult for the receiver of the reader to reconstruct the tag response signal from the tag. Here, the term “multipath fading” denotes the phenomenon in which radio waves received along different paths interact with each other due to multiple reflections from various objects, and then the amplitudes and phases of the radio waves change irregularly in a specific place.

### SUMMARY OF THE INVENTION

Accordingly, the present invention has been made keeping in mind the above problems occurring in the prior art, and an object of the present invention is to remarkably improve the tag recognition rate by periodically changing the direction of a beam transmitted from an RFID reader.

Another object of the present invention is to remarkably improve the recognition rate of tags attached to metal or liquid objects, which are vulnerable to an electromagnetic environment, by periodically changing the direction of the beam transmitted from an RFID reader.

A further object of the present invention is to minimize the power supplied to an apparatus for transmitting and receiving an RFID signal using beamforming.

Yet another object of the present invention is to recognize RFID tags located in a larger area.

In accordance with an aspect of the present invention to accomplish the above objects, there is provided an apparatus for transmitting and receiving a Radio Frequency Identification (RFID) signal using beamforming, including a reception unit for receiving power and RFID data signals from an RFID reader; a control unit for adjusting opening/closing periods of switches corresponding to respective paths through which the RF data signals pass, thus controlling the paths; and a transmission unit for converting phases of the RF data signals, which are distributed and transmitted to the paths, in response to the opening/closing periods of the switches, and then transmitting beams corresponding to the RF data signals while converting a pattern of the beams.

The reception unit may rectify a continuous wave signal, converts the continuous wave signal into direct current (DC) power, and then receive the DC power.

The reception unit may receive power, generated by converting a drive power signal received from the RFID reader via a DC rectification circuit.

The control unit may include a switch control unit for controlling the switches using square waves; and a power distribution unit for distributing the power equally to the paths.

The switch control unit may generate the square waves using astable multivibrators.

The control unit may adjust periods of the square waves based on resistance and capacitance of an internal resistor and an internal capacitor of each astable multivibrator, and control opening/closing times of the switches in response to the periods of the square waves.

The transmission unit may include a phase conversion unit for converting the phases of the RF data signals distributed and transmitted to respective paths; a beam pattern conversion unit for converting a beam pattern of an array antenna by combining phase-converted RF data signals with each other; and a transfer unit for transferring the beams.

The phase conversion unit may include a low-pass filter and a high-pass filter, each being implemented using lumped elements.

In accordance with another aspect of the present invention to accomplish the above objects, there is provided a method for transmitting and receiving a Radio Frequency Identification (RFID) signal using beamforming, including receiving power and RFID data signals from an RFID reader; adjusting opening/closing periods of switches corresponding to respective paths through which the RF data signals pass, thus controlling the paths; and converting phases of the RF data signals, which are distributed and transmitted to the paths, in response to the opening/closing periods of the switches, and then transmitting beams corresponding to the RF data signals while converting a pattern of the beams.

Receiving the power and the RF data signals may be configured to rectify a continuous wave signal, convert the continuous wave signal into direct current (DC) power, and then receive the DC power.

Receiving the power and the RF data signals may be configured to receive power, generated by converting a drive power signal received from the RFID reader via a DC rectification circuit.

Controlling the paths may include controlling the switches using square waves; and distributing the power equally to the paths.

Controlling the switches may be configured to generate the square waves using astable multivibrators.

Controlling the paths may be configured to adjust periods of the square waves based on resistance and capacitance of an internal resistor and an internal capacitor of each astable multivibrator, and control opening/closing times of the switches in response to the periods of the square waves.

Transmitting the beams may include converting the phases of the RF data signals distributed and transmitted to respective paths; converting a beam pattern of an array antenna by combining phase-converted RF data signals with each other; and a transfer unit for transferring the beams.

Converting the phases may be configured to convert the phases of the RF data signals using a low-pass filter and a high-pass filter, each being implemented using lumped elements.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a conventional typical 900 MHz UHF RFID system;

FIG. 2 is a block diagram showing an apparatus for transmitting and receiving an RFID signal using beamforming according to an embodiment of the present invention;

FIG. 3 is a block diagram showing the control unit shown in FIG. 2;

FIG. 4 is a block diagram showing the transmission unit shown in FIG. 2;

FIGS. 5 and 6 are diagrams showing an apparatus for transmitting and receiving an RFID signal using beamforming according to embodiments of the present invention;

FIG. 7 is a diagram showing the rectification of power in the RFID signal transmission and reception apparatus using beamforming according to an embodiment of the present invention;

FIG. 8 is a diagram showing examples of a square wave used by the control unit of the RFID signal transmission and reception apparatus using beamforming according to an embodiment of the present invention;

FIGS. 9 and 10 are diagrams showing examples of an astable multivibrator used in the RFID signal transmission and reception apparatus using beamforming according to an embodiment of the present invention;

FIG. 11 is a graph showing the loss values of input signals when a commercial phase converter is used in the RFID signal transmission and reception apparatus using beamforming according to an embodiment of the present invention;

FIG. 12 is a diagram showing an example of a phase converter used in the RFID signal transmission and reception apparatus using beamforming according to an embodiment of the present invention;

FIG. 13 is a diagram showing beam patterns depending on the variations in the phases of antennas constituting an array antenna in the RFID signal transmission and reception apparatus using beamforming according to an embodiment of the present invention; and

FIG. 14 is an operation flowchart showing a method for transmitting and receiving an RFID signal using beamforming according to an embodiment of the present invention.

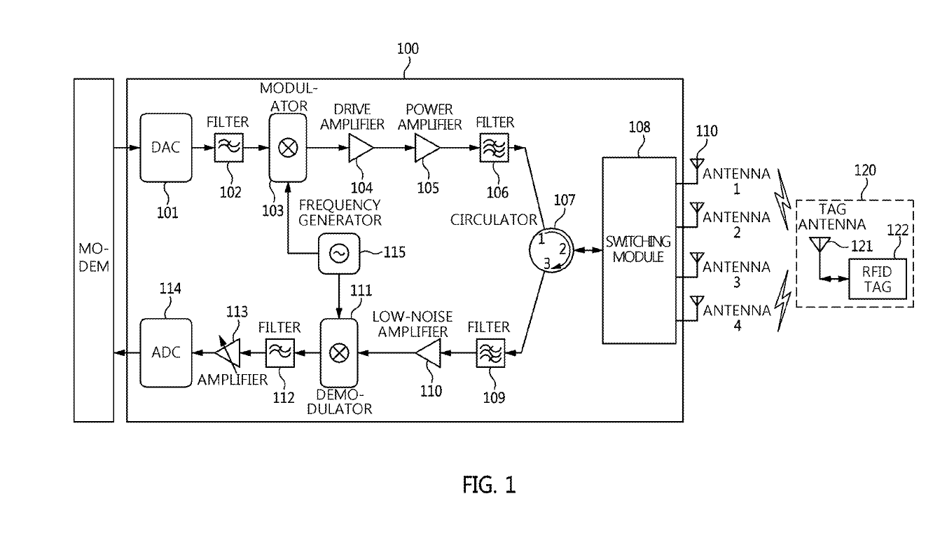

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

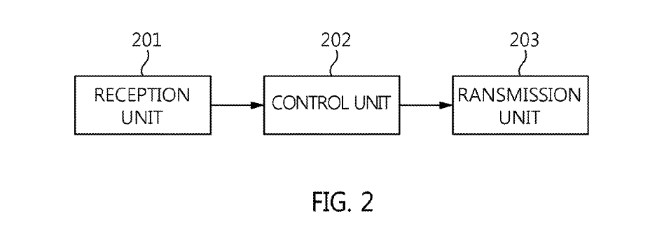

FIG. 2 is a block diagram showing an apparatus for transmitting and receiving an RFID signal using beamforming according to an embodiment of the present invention.

Referring to FIG. 2, the apparatus for transmitting and receiving an RFID signal using beamforming according to the embodiment of the present invention includes a reception unit 201, a control unit 202, and a transmission unit 203.

The reception unit 201 receives power and RF data signals from an RFID reader.

Here, the RF data signals may include a signal for communication with an RFID tag or a control signal for the RFID signal transmission and reception apparatus using beamforming

In this case, when power is received from the RFID reader, a drive power signal received from the RFID reader may be converted into Direct Current (DC) power using a DC rectification circuit, and then the DC power may be received.

Here, when power is received from the RFID reader, a Continuous Wave (CW) signal supplied from the RFID reader may be rectified and received through an RF rectification circuit. Typically, a 900 MHz RFID reader may output a power of 1 W, which may drive the RFID signal transmission and reception apparatus using beamforming

The power obtained by rectifying the CW signal via the RF rectification circuit may be DC power.

The control unit 202 controls paths through which the RF data signals pass by controlling switches corresponding to respective paths.

The method by which the control unit 202 controls the switches is not especially limited. For example, the switching times of the switches may be changed using a digital control element. Alternatively, the switches may be controlled using square waves.

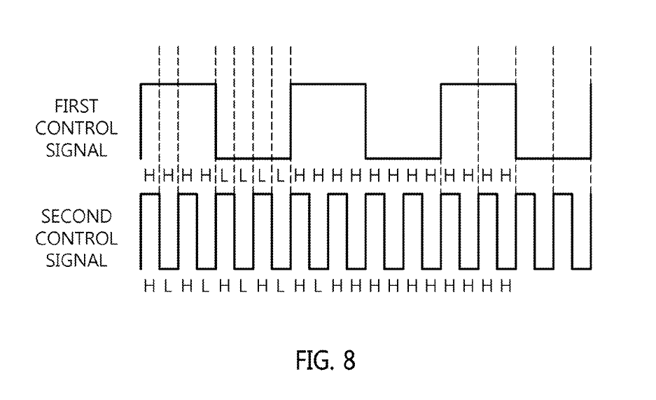

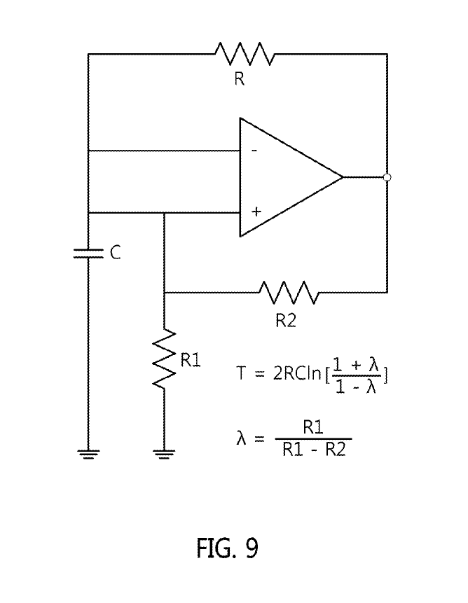

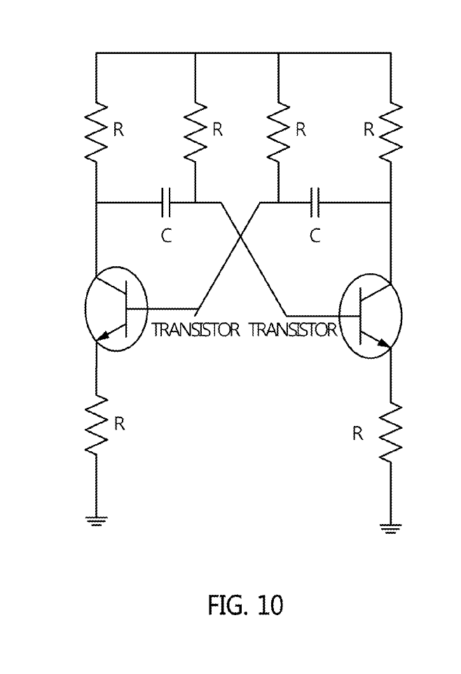

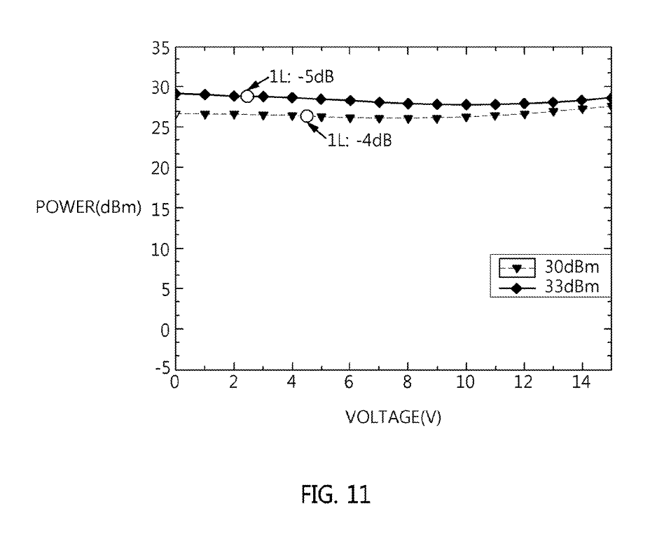

Here, the method of generating square waves is not especially limited. Such a square wave may be generated using an astable multivibrator, as shown in FIG. 9 or 10. The method of controlling the switches using square waves will be described in detail later with reference to FIG. 8.

In this case, the control unit 202 may distribute the power, received through the reception unit 201, equally to respective paths.

The control unit 202 may control the switches by controlling the opening/closing times of the switches in response to the periods of the square waves.

Here, the periods of the square waves may also be adjusted. For example, the periods of the square waves may be adjusted based on the resistance and capacitance of the internal resistor and internal capacitor of each astable multivibrator.

The transmission unit 203 converts the pattern of beams corresponding to the RF data signals transmitted to respective paths by converting the phases of the RF data signals, and then transmits the beams.

Alternatively, the transmission unit 203 may convert the beam pattern of the array antenna by converting the phases of the RF data signals, which are transmitted to respective paths, and combining the RF data signals, and may then transmit the beams.

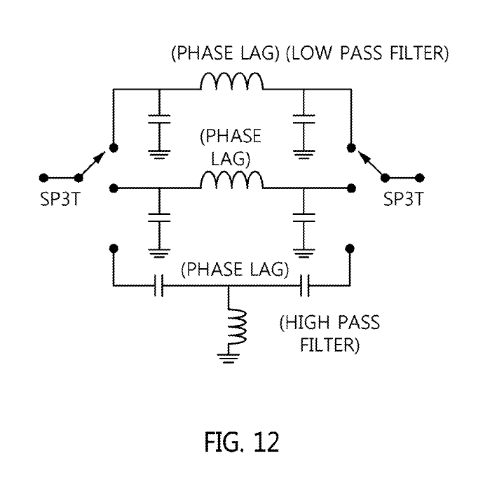

Here, the method by which the transmission unit 203 converts the phases of RF data signals is not especially limited. For example, the phases of respective RF data signals may be changed using a phase conversion device composed of lumped elements, as shown in FIG. 12.

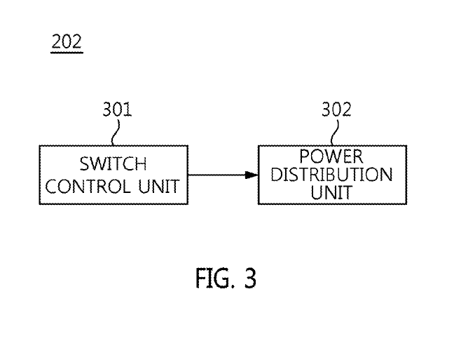

FIG. 3 is a block diagram showing the control unit 202 shown in FIG. 2.

Referring to FIG. 3, the control unit 202 includes a switch control unit 301 and a power distribution unit 302.

The switch control unit 301 controls switches based on square waves.

Here, the types of switches are not especially limited. For example, when there are N paths, Single Pole N Throw (SPNT) switches may be used.

Further, the method by which the switch control unit 301 controls the switches is not especially limited. For example, the switching times of the switches may be changed using a digital control element. Alternatively, the switches may be controlled using square waves.

In this case, the method of generating square waves is not limited. Such a square wave may be generated using the astable multivibrator shown in FIG. 9 or 10. The method of controlling switches using square waves will be described later with reference to FIG. 8.

The switch control unit 301 may control the switches by controlling the opening/closing times of the switches in response to the periods of square waves.

The periods of the square waves may be adjusted. For example, the periods of the square waves may be adjusted based on the resistance and capacitance of the internal resistor and internal capacitor of each astable multivibrator.

The power distribution unit 302 equally distributes power to respective paths, through which the RF data signals pass.

Here, the reason for distributing power equally is that, if power is distributed differently to respective paths upon performing beamforming, the intensities of powers at which RF data signals are output from the respective antennas are changed, and the incidence of errors increases when performing beamforming.

The method by which the power distribution unit 302 distributes power equally is not especially limited. For example, when the number of paths is N, the power may be equally distributed using an N-branch power distributor.

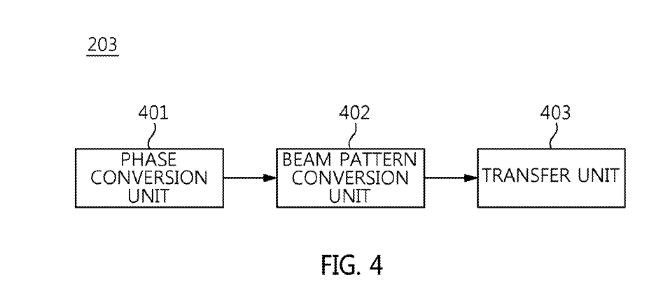

FIG. 4 is a block diagram showing the transmission unit shown in FIG. 2.

Referring to FIG. 4, the transmission unit 203 includes a phase conversion unit 401, a beam pattern conversion unit 402, and a transfer unit 403.

The phase conversion unit 401 converts the phases of RF data signals distributed and transmitted to respective paths.

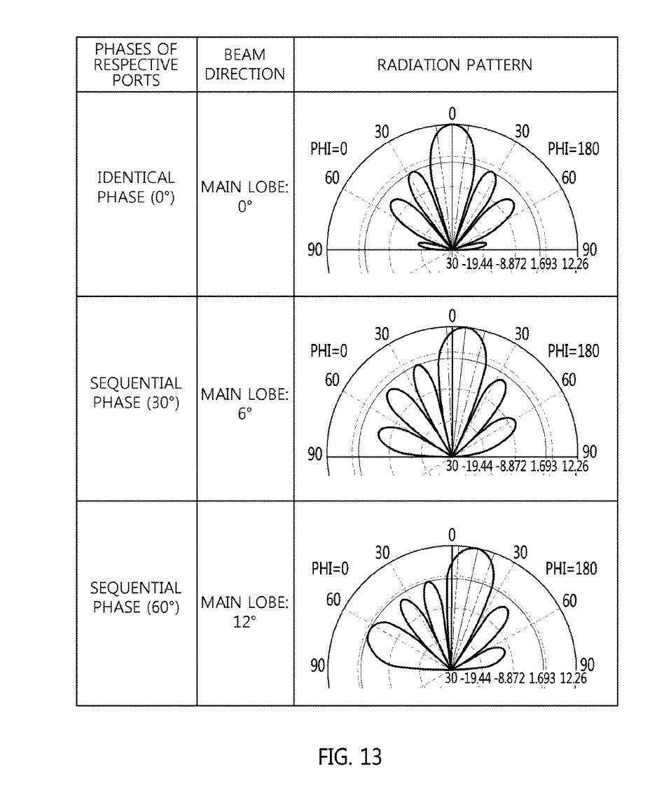

The method by which the phase conversion unit 401 converts the phases of RF data signals is not especially limited. For example, there is a method of converting the phases by changing the physical lengths of transmission lines through which the RF data signals pass. However, this method is disadvantageous in that RFID signals that use radio waves in a UHF band (900 MHz) have a relatively long wavelength of about 30 cm, thus increasing the size of the phase conversion unit. Alternatively, there is a method of converting the phases using an analog type varactor diode. However, this method entails a large loss of high-power input signals. Accordingly, in an RFID signal transmission and reception apparatus using RFID tags, which are present in a relatively large area, it is difficult to use such a method of converting phases using the varactor diode. Therefore, the present invention proposes the use of a phase converter using lumped elements, as shown in FIG. 13. The phase converter using lumped elements will be described later in detail later with reference to FIG. 13.

The beam pattern conversion unit 402 converts the pattern of the beams to be transmitted through an array antenna by combining phase-converted RF data signals with each other.

Here, the array antenna may denote a set of multiple antennas that are arranged. The arrangement of the antennas is not especially limited. For example, the antennas may be arranged in a line or in a circular shape.

The beam pattern may denote the shape of the transfer range of a radio wave in which RF data signals are combined and which is transmitted from the array antenna. Examples of the beam pattern are illustrated in FIG. 13.

The transfer unit 403 transfers the beams.

Here, the transfer unit 403 transfers the beams corresponding to the beam pattern converted by the beam pattern conversion unit 402.

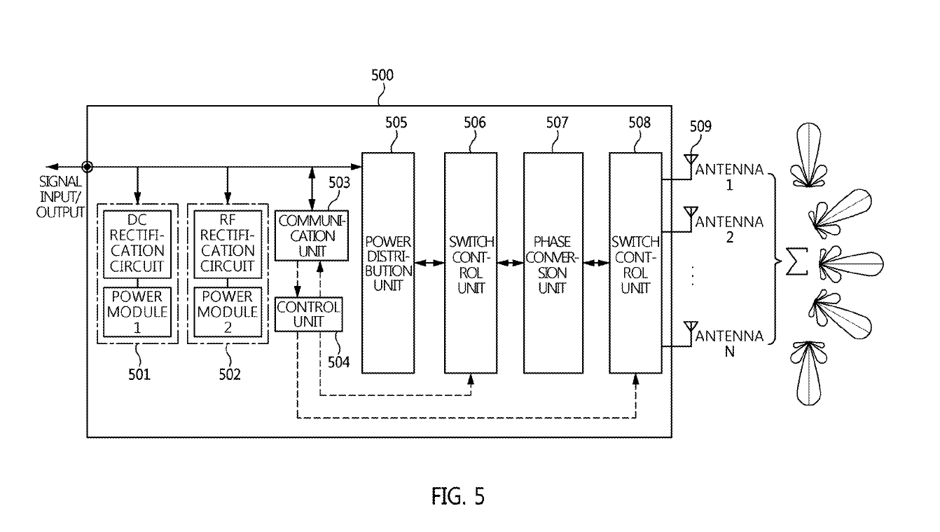

FIG. 5 is a diagram showing an apparatus for transmitting and receiving an RFID signal using beamforming according to an embodiment of the present invention.

Referring to FIG. 5, an apparatus 500 for transmitting and receiving an RFID signal using beamforming according to an embodiment of the present invention includes power units 501 and 502, a communication unit 503, a control unit 504, a power distribution unit 505, switch control units 506 and 508, a phase conversion unit 507, and antennas 509.

The RFID signal transmission and reception apparatus 500 may be either embedded in an RFID reader or produced in a module type. In the case of the module type, the RFID signal transmission and reception apparatus may be connected to the RFID reader through an RF cable or a connector.

The power unit 501 may convert the signal received from the RFID reader into stable power via a DC rectification circuit and may supply the power to the components of the RFID signal transmission and reception apparatus 500. Further, when the RFID reader and an RFID tag communicate with each other, the power unit 501 may combine a DC signal with a Continuous Wave (CW) signal received from the RFID reader and transfer a resulting signal.

The power unit 502 may rectify the CW signal received from the RFID reader via an RF rectification circuit and then supply rectified power to the components of the RFID signal transmission and reception apparatus 500.

Here, the power unit 501 or 502 may be selectively used.

The communication unit 503 is used when the RFID reader and the RFID signal transmission and reception apparatus 500 communicate with each other. Although not shown in FIG. 5, the communication unit 503 includes a signal transmission unit and a signal reception unit.

Here, the signal reception unit may receive a control signal for the RFID signal transmission and reception apparatus from the RFID reader and transfer the control signal to the control unit 504.

The control signal for the RFID signal transmission and reception apparatus may be a signal in a high or low state, and may be transferred to the control unit 504 in the form of a baseband signal that is not modulated into an RF signal.

Here, the signal transmission unit may transfer the information about the state of the RFID signal transmission and reception apparatus to the RFID reader.

The information about the state of the RFID signal transmission and reception apparatus may include information about whether a control signal has been received, about whether the apparatus is operating normally, or about the level of drive power.

The control unit 504 may be operated in a steady state after the power has been supplied from the power unit 501 or 502.

Here, the control unit 504 is a device for executing the commands from the RFID reader, which are received through the communication unit 503, and may control the switch control units 506 and 508.

In this case, the power distribution unit 505 may distribute the same power to two or more paths.

The reason for distributing power equally is that, if power is distributed differently to respective paths when performing beamforming, the intensities of powers at which RF data signals are output from the respective antennas are changed, and the incidence of errors increases when performing beamforming.

Here, the method by which the power distribution unit 505 distributes power equally is not especially limited. For example, when the number of paths is N, the power may be equally distributed using an N-branch power distributor.

The switch control units 506 and 508 are components for establishing paths so that the RF data signals pass through designated paths, and may be implemented using N-branch switches to designate multiple paths.

The phase conversion unit 507 functions to convert the phases of RF data signals output from the power distribution unit.

Here, the method by which the phase conversion unit 507 converts the phases of the RF data signals is not especially limited. For example, there is a method of converting the phases by changing the physical lengths of transmission lines through which the RF data signals pass. However, this method is disadvantageous in that RFID signals that use radio waves in a UHF band (900 MHz) have a relatively long wavelength of about 30 cm, thus increasing the size of the phase conversion unit. Alternatively, there is a method of converting the phases using an analog type varactor diode. However, this method entails a large loss of high-power input signals. Accordingly, in an RFID signal transmission and reception apparatus using RFID tags, which are present in a relatively large area, it is difficult to use such a method of converting phases using the varactor diode. Therefore, the present invention proposes the use of a phase converter using lumped elements, as shown in FIG. 13. The phase converter using lumped elements will be described later with reference to FIG. 13.

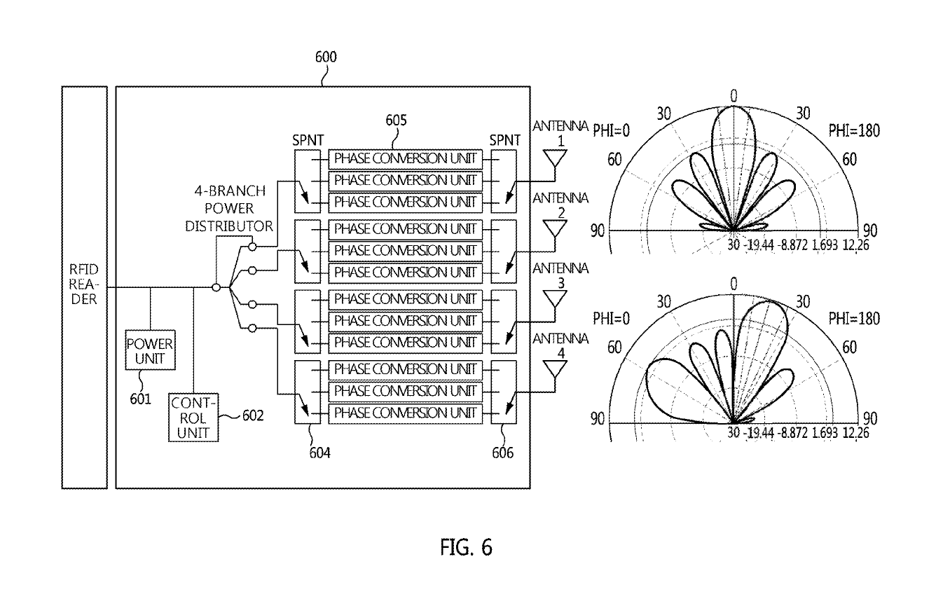

FIG. 6 is a diagram showing an apparatus for transmitting and receiving an RFID signal using beamforming according to another embodiment of the present invention. In particular, FIG. 6 illustrates an embodiment in which RF data signals are distributed to four paths and beamforming is performed using an array antenna composed of four antennas and in which RF data signals are transmitted.

Referring to FIG. 6, the RFID signal transmission and reception apparatus using beamforming according to the embodiment of the present invention includes a power unit 601, a control unit 602, a 4-branch power distributor 603, Single-Pole n-Throw (SPNT) switches 604 and 606, and phase conversion units 605.

The power unit 601 may rectify a CW signal transmitted from an RFID reader into DC power and use the DC power to obtain the power required in order to operate the RFID signal transmission and reception apparatus.

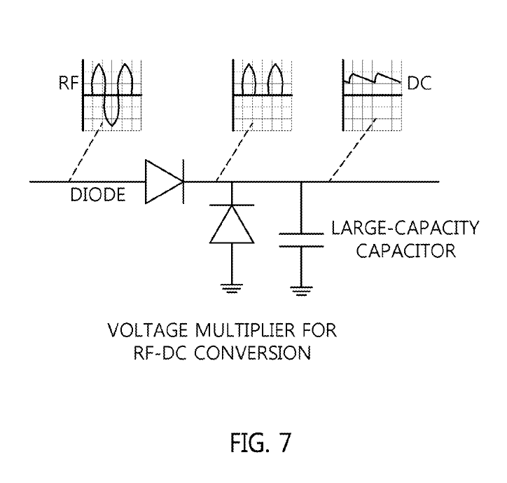

Here, the power unit 601 may convert the CW signal into DC power using a multi-stage voltage multiplier structure that exploits Schottky diodes and a large-capacity capacitor, shown in FIG. 7, in order to increase the energy conversion efficiency.

The control unit 602 may establish paths of the RF data signals branched from the 4-branch power distributor 603.

Here, to establish the paths of the RF data signals, set values for SPNT switches may be designated.

Here, the designation of the set values for the SPNT switches may mean the determination of whether to open or close the switches.

Upon determining whether to open or close the switches, the switches may be controlled using square waves.

With reference to FIG. 8, the method of controlling the switches using square waves is described in detail. When, among the control signals generated in the form of square waves, a high value is set to “H” and a low value is set to “L”, and a first control signal and a second control signal are sequentially indicated, a total of four types of signals, namely (H,H), (H,L), (H,H), (H,L), (L,H), (L,L), (L,H), and (L,L), may be generated. By using the controls signals shown in FIG. 8, the control unit may generate signals required to open or close the 4-branch switches. In FIG. 8, although a method of controlling four switches using two control signals has been illustrated, the number of switches does not need to be four. It is apparent to those skilled in the art that it is possible to control 2^{N} switches using N control signals generated by N astable multivibrators.

Here, the method of generating square waves is not especially limited. Such a square wave may be generated using the astable multivibrator shown in FIG. 9 or 10.

Here, the control unit 602 may control the switches by controlling the opening/closing times of switches in response to the periods of the square waves.

In this case, the periods of the square waves may also be adjusted. For example, the periods of the square waves may be adjusted based on the resistance and capacitance of the internal resistor and internal capacitor of each astable multivibrator. By adjusting the periods of the square waves, the opening/closing times of the switches may be adjusted and the duration of the beam pattern may also be adjusted.

The phase conversion units 605 convert the beam pattern of the array antenna by adjusting the phase of the array antenna.

Here, the method by which the phase conversion units 605 convert the phases of RF data signals is not especially limited. For example, there is a method of converting the phases by changing the physical lengths of transmission lines through which the RF data signals pass. However, this method is disadvantageous in that RFID signals that use radio waves in a UHF band (900 MHz) have a relatively long wavelength of about 30 cm, thus increasing the size of the phase conversion unit. Alternatively, there is a method of converting the phases using an analog type varactor diode. However, this method entails a large loss of high-power input signals. Accordingly, in an RFID signal transmission and reception apparatus using RFID tags, which are present in a relatively large area, it is difficult to use such a method of converting phases using the varactor diode. Therefore, the present invention proposes the use of the phase converter using lumped elements, as shown in FIG. 13.

FIGS. 9 and 10 are diagrams showing examples of the astable multivibrator used by the RFID signal transmission and reception apparatus using beamforming according to an embodiment of the present invention.

FIG. 9 is a diagram showing an astable multivibrator for generating a square wave using an operational amplifier.

FIG. 10 is a diagram showing an astable multivibrator in which the emitters of two transistors are coupled to each other to generate a square wave, wherein the two transistors are alternately powered on and off to generate the square wave.

Here, the types of transistors are not especially limited. For example, a Bipolar Junction Transistor (BJT) or a Metal-Oxide-Semiconductor Field-Effect Transistor (MOSFET) may be used as the transistor.

FIG. 12 is a diagram showing an example of a phase converter used in the RFID signal transmission and reception apparatus using beamforming according to an embodiment of the present invention.

Referring to FIG. 12, the phase converter used in the RFID signal transmission and reception apparatus using beamforming according to the embodiment of the present invention includes a low-pass filter and a high-pass filter, which are implemented using lumped elements including capacitors and inductors, and Single Pole 3 Throws (SP3T) switches.

The low-pass filter may cause the phase of an RF data signal to lag.

The high-pass filter may cause the phase of an RF data signal to lead.

The phase converter may convert the phase of the RF data signal by causing the RF data signal to pass through the low-pass filter or the high-pass filter using the SP3T switches.

The phase converter may be implemented using capacitors and inductors, which are relatively cheap elements. When the loss of an output signal is measured, a loss of about 1 dB is exhibited, thus realizing the effect of reducing loss.

FIG. 13 is a diagram showing beam patterns depending on the variations in the phases of antennas constituting an array antenna in the RFID signal transmission and reception apparatus using beamforming according to an embodiment of the present invention.

More specifically, FIG. 13 is a diagram showing the patterns of beams generated when the phases of four antennas in an array antenna having four antennas are respectively changed.

In this case, the cases where the phases of the four antennas are identical to each other (in-phase), where the phases sequentially have a phase difference of 30°, and where the phases of the four antennas sequentially have a phase difference of 60° are illustrated in the drawing.

When the phases of the four antennas are identical to each other, the direction of a beam pattern may be formed such that the angle of a main lobe (main beam) is 0°.

Further, when the phases of the four antennas sequentially have a difference of 30°, the direction of a beam pattern may be formed such that the angle of a main lobe is 6°.

Furthermore, when the phases of the four antennas sequentially have a difference of 60°, the direction of a beam pattern may be formed such that the angle of a main lobe is 12°.

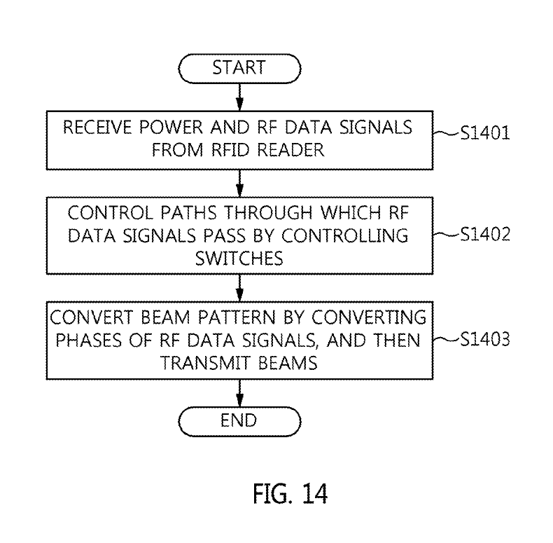

FIG. 14 is an operation flowchart showing a method for transmitting and receiving an RFID signal using beamforming according to an embodiment of the present invention.

Referring to FIG. 14, power and RF data signals are received from an RFID reader at step S1401.

In this case, the RF data signals includes a signal for communication with an RFID tag or a control signal for the RFID signal transmission and reception apparatus using beamforming.

Here, upon receiving power from the RFID reader, a drive power signal received from the RFID reader may be converted into DC power via a DC rectification circuit, and the DC power may be received.

Alternatively, upon receiving power from the RFID reader, a CW signal supplied from the RFID reader may be rectified via an RF rectification circuit, and then rectified power may be received. Typically, a power of 1 W may be output from a 900 MHz RFID reader, and may be used to drive the RFID signal transmission and reception apparatus using beamforming.

Here, the power obtained by rectifying the CW signal via the RF rectification circuit may be DC power.

Further, the paths through which RF data signals pass are controlled by controlling switches at step S1402.

Here, the method of controlling the switches is not especially limited. For example, the switching times of the switches may be changed using a digital control element. For example, the switches may be controlled using square waves.

The method of generating square waves is not especially limited. For example, square waves may be generated using the astable multivibrator shown in FIG. 9 or 10. The method of controlling the switches using square waves has been described above with reference to FIG. 8.

Here, the switches may be controlled by controlling the opening/closing times of the switches in response to the periods of the square waves.

The periods of the square waves may be adjusted based on the resistance and capacitance of the internal resistor and internal capacitor of each astable multivibrator.

Further, the pattern of the beams is converted by converting the phases of RF data signals, and then the pattern-converted beams are transmitted at step S1403.

Alternatively, the phases of the RF data signals which are transmitted to respective paths may be converted, and then the resulting RF data signals may be combined to convert the beam pattern of the array antenna, and then the beams may be transmitted.

The method of converting the phases of RF data signals is not especially limited. For example, the phases of respective RF data signals may be converted using a phase conversion device composed of lumped elements, as shown in FIG. 12.

Accordingly, the RFID signal transmission and reception apparatus using beamforming according to the present invention is attached to an RFID reader to periodically change the direction of beams, thus enabling the tag recognition rate to be remarkably improved.

Further, the present invention is configured such that the RFID signal transmission and reception apparatus using beamforming is attached to an RFID reader to periodically change the direction of beams, thus enabling the recognition rate of tags attached to metal or liquid materials, which are vulnerable to an electromagnetic environment, to be remarkably improved.

Furthermore, the present invention supplies required power using the transmission power of an RFID reader without requiring an external power supply device, and thus separate power is not required.

Furthermore, the present invention may recognize RFID tags which are present in a larger area by using a phase converter, which has low loss characteristics for a high-power signal from the RFID reader.

As described above, in the apparatus and method for transmitting and receiving an RFID signal using beamforming according to the present invention, the configurations and schemes in the above-described embodiments are not limitedly applied, and some or all of the above embodiments can be selectively combined and configured so that various modifications are possible.

What is claimed is:

1. An apparatus for transmitting and receiving a Radio Frequency Identification (RFID) signal using beamforming, comprising:
a reception unit for receiving power and RFID data signals from an RFID reader;
a control unit for adjusting opening/closing periods of switches corresponding to respective paths through which the RF data signals pass, thus controlling the paths; and
a transmission unit for converting phases of the RF data signals, which are distributed and transmitted to the paths, in response to the opening/closing periods of the switches, and then transmitting beams corresponding to the RF data signals while converting a pattern of the beams.

2. The apparatus of claim 1, wherein the reception unit rectifies a continuous wave signal, converts the continuous wave signal into direct current (DC) power, and then receives the DC power.

3. The apparatus of claim 1, wherein the reception unit receives power, generated by converting a drive power signal received from the RFID reader via a DC rectification circuit.

4. The apparatus of claim 1, wherein the control unit comprises:
a switch control unit for controlling the switches using square waves; and
a power distribution unit for distributing the power equally to the paths.

5. The apparatus of claim 4, wherein the switch control unit generates the square waves using astable multivibrators.

6. The apparatus of claim 5, wherein the control unit adjusts periods of the square waves based on resistance and capacitance of an internal resistor and an internal capacitor of each astable multivibrator, and controls opening/closing times of the switches in response to the periods of the square waves.

7. The apparatus of claim 6, wherein the transmission unit comprises:
a phase conversion unit for converting the phases of the RF data signals distributed and transmitted to respective paths;
a beam pattern conversion unit for converting a beam pattern of an array antenna by combining phase-converted RF data signals with each other; and
a transfer unit for transferring the beams.

8. The apparatus of claim 7, wherein the phase conversion unit comprises a low-pass filter and a high-pass filter, each being implemented using lumped elements.

9. A method for transmitting and receiving a Radio Frequency Identification (RFID) signal using beamforming, comprising:
receiving power and RFID data signals from an RFID reader;
adjusting opening/closing periods of switches corresponding to respective paths through which the RF data signals pass, thus controlling the paths; and
converting phases of the RF data signals, which are distributed and transmitted to the paths, in response to the opening/closing periods of the switches, and then transmitting beams corresponding to the RF data signals while converting a pattern of the beams.

10. The method of claim 9, wherein receiving the power and the RF data signals is configured to rectify a continuous wave signal, convert the continuous wave signal into direct current (DC) power, and then receive the DC power.

11. The method of claim 9, wherein receiving the power and the RF data signals is configured to receive power, generated by converting a drive power signal received from the RFID reader via a DC rectification circuit.

12. The method of claim 9, wherein controlling the paths comprises:
controlling the switches using square waves; and
distributing the power equally to the paths.

13. The method of claim 12, wherein controlling the switches is configured to generate the square waves using astable multivibrators.

14. The method of claim 13, wherein controlling the paths is configured to adjust periods of the square waves based on resistance and capacitance of an internal resistor and an internal capacitor of each astable multivibrator, and control opening/closing times of the switches in response to the periods of the square waves.

15. The method of claim 12, wherein transmitting the beams comprises:
converting the phases of the RF data signals distributed and transmitted to respective paths;
converting a beam pattern of an array antenna by combining phase-converted RF data signals with each other; and
a transfer unit for transferring the beams.

16. The method of claim 15, wherein converting the phases is configured to convert the phases of the RF data signals using a low-pass filter and a high-pass filter, each being implemented using lumped elements.
